(19) United States
(12) Patent Application Publication
(10) Pub. No.: US 2006/0147079 A1
(43) Pub. Date: Jul. 6, 2006

(54) Earphone

(75) Inventor: Mikael Jaakkola, Turku (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/026,561

(22) Filed: Dec. 30, 2004

(51) Int. Cl. H04R 25/00

(52) U.S. Cl. 381/380; 381/374

(57) ABSTRACT

An earphone for multiple listening applications is configurable between a first operative state defining a first ear canal interface for call management listening applications and a second operative state defining a second ear canal interface for music listening applications.

### TECHNICAL FIELD

The present invention relates generally to headsets and deals more particularly with a configurable earphone for multiple listening applications.

### BACKGROUND OF THE INVENTION

Headsets are gaining in popularity in and out of the workplace as more and more users have jobs requiring that they spend a substantial amount of time on the telephone or users simply desire to listen to audio or to speak on the telephone with their hands free to perform other tasks. Headsets, particularly earphones typically available for use with portable electronic equipment such as mobile telephones and music players are ill-fitting and not designed to couple tightly to the ear opening of a user and therefore provide poor isolation from external audible noise. Prior art headphones such as illustrated in FIG. 2 are available that cover the outer ear and provide better acoustic isolation, but they are generally bulky and unattractive and poorly suitable in many situations particularly where portable voice communication or music playing devices are used. Additionally, the failure of most earphones to provide acoustic isolation frequently results in the user compensating by increasing the level of the sound and the user experiences a less than desirable listening experience particularly for listening to music. Such prior art headsets have poor acoustic coupling to the ear canal which poor acoustic coupling is compensated for by utilizing a larger speaker and/or more power to drive the speaker to provide sufficient volume to be heard over the background noise. The disadvantage of increased power usage is not usually a major concern for wired devices but generally reduces battery life for mobile, portable electronic music players and mobile telephones.

It is also known in the prior art to provide a type of headset referred to as an “in-the-ear” headset which is also referred to as an “earbud” or concha style headset such as for example as illustrated in FIG. 3 and described in U.S. Pat. No. 6,810,987 which position the speaker inside the concha in close proximity to the ear canal between the inner surfaces of the tragus slot and concha wall to retain the speaker. This prior art configuration operates with lower speaker drive power and has improved acoustic coupling to the user's ear. However, such prior art earbuds are uncomfortable to wear and are generally not desirable for call management listening applications.

Another prior art earbud headset is illustrated in FIG. 4 wherein the earplug is inserted into the ear canal to provide tight acoustic coupling to block out external sounds to provide good music listening. The advantage of such a prior art earplug is a smaller speaker element can be utilized. One major disadvantage with such a prior art earplug, which is also known as a deep thrust earplug, is that the earplug is difficult to fit into place in the ear canal and is uncomfortable to the user. Prior art earphones such as illustrated in FIG. 4 are disclosed for example in WIPO Publications WO2004/064443 A2 and WO2004/077924 A2.

Prior art headsets and earplugs are not suitable to provide both call management listening application and a music listening application utilizing the same headset. Accordingly, there is a need for a headset particularly an earphone for use in multiple listening applications to provide a good call management listening experience and a good music listening experience.

### SUMMARY OF THE INVENTION

In accordance with the preset invention, an earphone for multiple applications such as call management listening applications and music listening applications is presented. The earphone includes a main body element having a first side defining an ear facing portion and a second side disposed in a spaced relation opposite the first side and defining a closed portion. The ear facing portion is configurable and has two operative states wherein the first state defines a first ear canal interface for call management listening applications and the second state defines a second ear canal interface for music listening applications. The ear facing portion further comprises a communication channel member having a sound emitting end portion and has a pre-defined axial length dimension. The communication channel member has a suitably sized and shaped outer surface for complementary engagement with the outer portion of the entry to the ear canal. An outer peripheral cup wall is substantially concentric and in a spaced relation with the communication channel member and the rim of the cup wall is suitably sized and shaped for overlapping coverage and contact with the ear. The outer peripheral cup wall is made of a suitable memory retention deformable material and has a first axial length in the first operative state wherein the sound emitting end portion of the communication channel member extends a first distance above a plane passing transversely through the rim of the cup wall such that the sound emitting end portion of the communication channel member is positioned in a spaced distance with respect to the entry to the ear canal when the earphone is worn by a user. The outer peripheral cup wall is folded back and defines a folded rim having a second axial length less than the first axial length in its second operative state wherein the sound emitting end portion of the communication channel member extends a second distance above a plane passing transversely through the folded rim of the cup wall such that the outer surface of the communication channel member sound emitting end portion is positioned in contact with the entry to the ear canal when the earplug is worn by a user. The earphone further includes a speaker element carried by the main body element for producing audio signals such as voice communications and music. The outer peripheral cup wall is made of a suitable elastomer material.

### BRIEF DESCRIPTION OF THE DRAWINGS

FIG. 1 is an illustration of the relevant parts of a typical human ear.

FIG. 2 is a schematic illustration of a prior art headset covering the ears of a user.

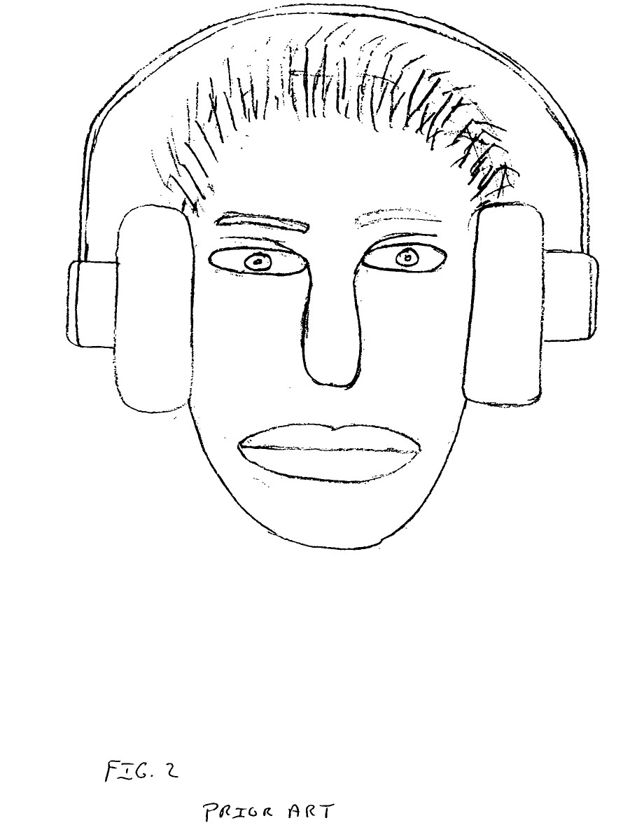

FIG. 3 is a schematic illustration of a prior art earbud headset shown in the ear of a user.

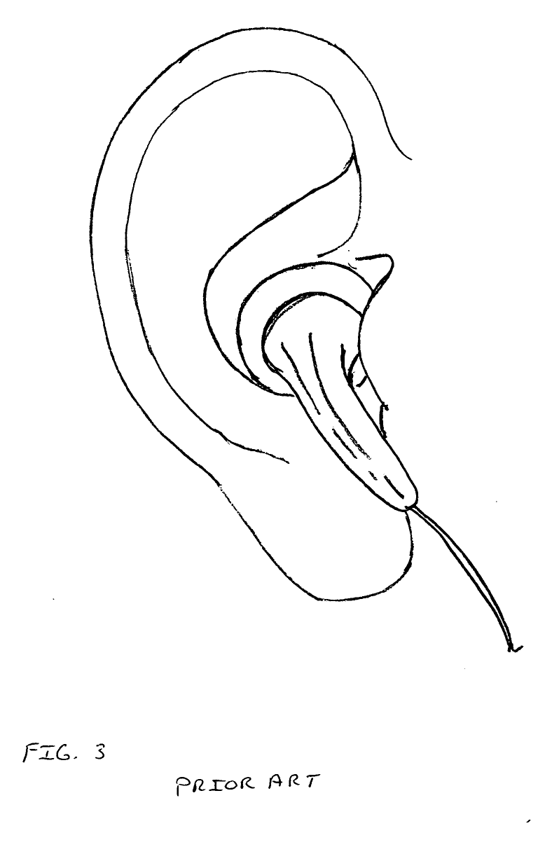

FIG. 4 is a schematic illustration of a prior art earbud headset shown inserted into the ear canal of a user.

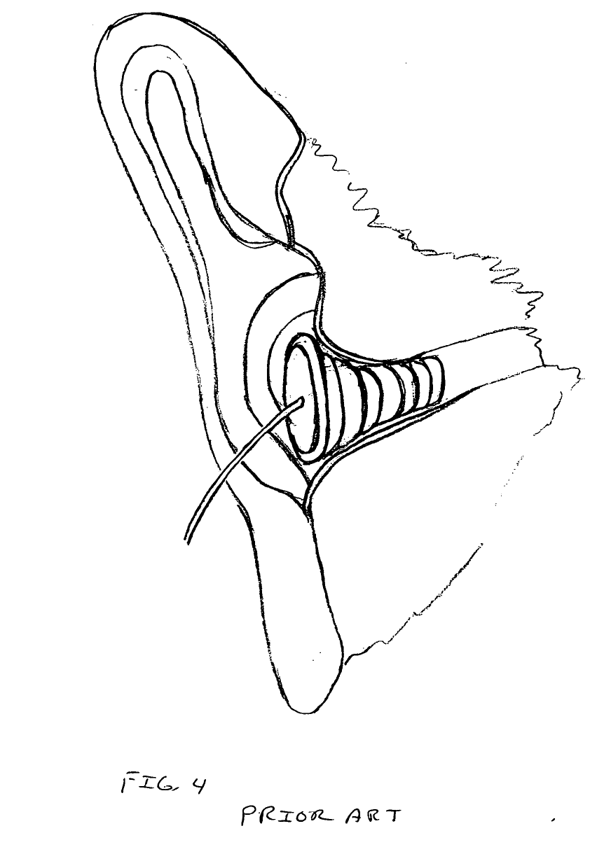

FIG. 5 is a schematic illustration of the headset embodying the present invention showing the configurable earplug in its first operative configuration for interfacing with the ear canal of a user.

FIG. 6 is a schematic illustration of the headset embodying the present invention showing the configurable earplug in is second operative configuration for interfacing with the ear canal of a user.

FIG. 7 is a schematic illustration of the earplug of the headset embodying the present invention in its first operative configuration showing it in contact with a user's ear.

FIG. 8 is a schematic illustration of the earplug of the head set embodying the present invention in its second operative configuration showing it in contact with a user's ear.

FIG. 9 is a schematic cross-section partially cut away view of the earplug of the headset embodying the present invention in its second operative configuration revealing the speaker element.

### WRITTEN DESCRIPTION OF PREFERRED EMBODIMENTS

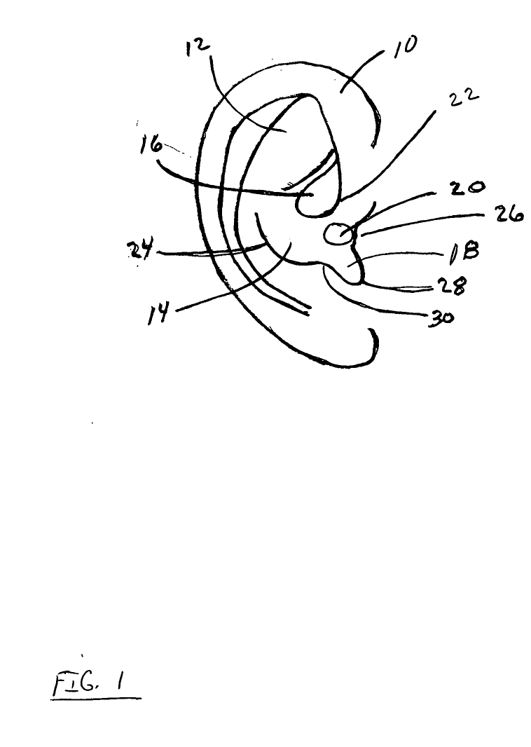

For illustration purposes and to aid in the understanding the present invention, a typical human ear is illustrated in FIG. 1. The outer ear, or pinna, is an irregularly concave cartilaginous member including number of eminences and depressions which give each ear a distinct shape and form. The helix 10 is the curved outer rim of the ear. Below the helix 10 is the antihelix 12. The antihelix 12 is a curved prominence which describes a curve around the concha 14, a deep cavity containing the entry to the ear canal 20. The concha 14 is divided into two parts, the upper concha 16 and the lower concha 18, by the crux of the helix 22 which curves around the outside of the ear, and extends inwards at about the vertical midpoint of the ear. The upper concha 16 lies above the crux of the helix 22 and below the antihelix 12. The lower concha 18 lies below the crux of the helix 22 and surrounds the entry to the ear canal 20. The conchal wall 24 separates the concha 14 from the antihelix 12. In front of the lower concha 18 and projecting backwards from the front of the ear is the tragus 26, a small semicircular prominence. Opposite the tragus 26 and separated from it by the deep curvature of the intertragic notch 28 is the antitragus 30. The intertragic notch 28 is formed between the tragus 26 and the antitragus 30.

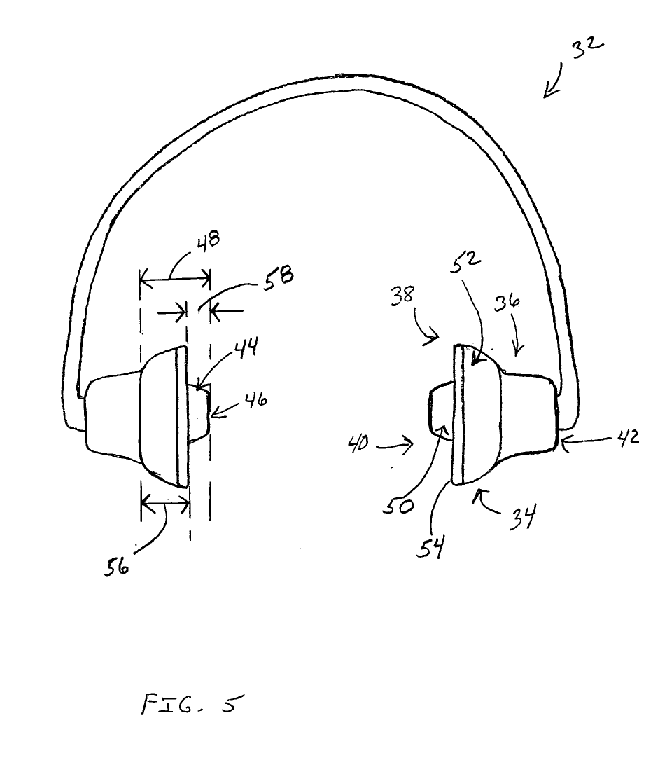

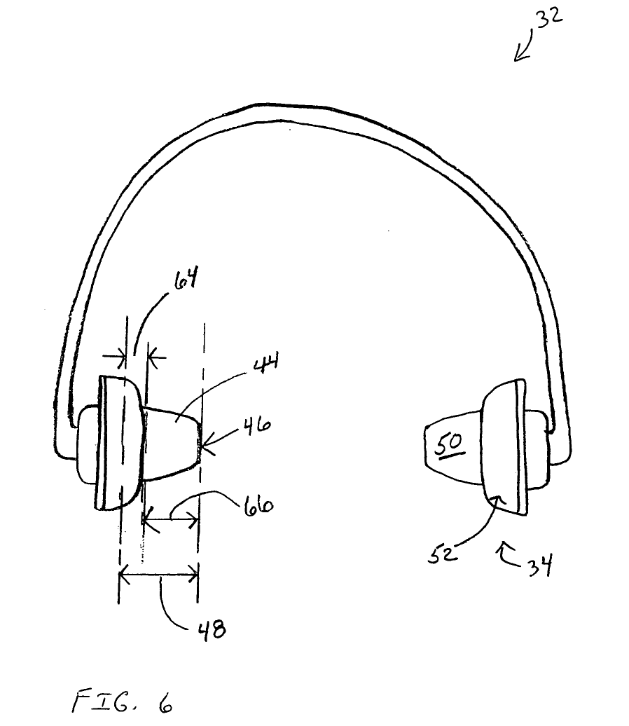

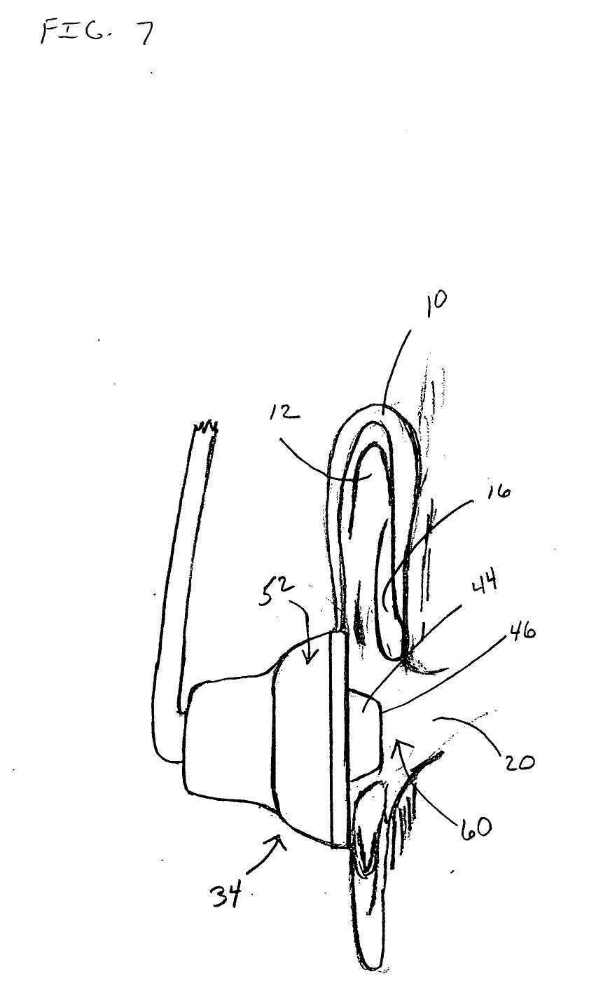

FIG. 5 illustrates schematically one embodiment of the present invention showing a headset generally designated 32 having a configurable earplug generally designated 34 in its first operative configuration for interfacing with the ear canal of a user for call management listening applications. FIG. 6 illustrates schematically the headset 32 embodying the present invention showing the configurable earplug 34 in its second operative configuration for interfacing with the ear canal of a user for music listening applications. The earplug 34 includes a main body element 36 having a first side 38 defining an ear facing portion generally designated 40 and a second side generally designated 42 disposed in a spaced relation opposite the first side 38 and defining a closed portion. The ear facing portion 40 includes a communication channel member generally designated 44 which is generally conical shaped and has a sound emitting end portion 46 having a pre-defined axial length dimension 48. The communication channel member 44 has a suitably sized and shaped outer surface 50 for complimentary engagement with the lower concha or outer portion of the entry to the ear canal 20. The ear facing portion 40 also includes an outer peripheral cup wall generally designated 52 which is substantially concentric with and in a spaced relationship to the communication channel member 44. The rim 54 formed at the edge of the outer peripheral cup wall is suitably sized and shaped for overlapping coverage and contact with the helix 10 of the user's ear. The outer peripheral cup wall is made of a suitable memory retention deformable material such as an elastomer material and has a first axial length 56 in its first operative state wherein the sound emitting end portion 46 of the communication channel member 44 extends a first distance dimension 58 above a plane passing transversely through the rim 54 of the outer peripheral cup wall 52 such that the sound emitting end portion 46 of the communication channel member 44 is positioned in a spaced distance with respect to the entry to the ear canal 20 as illustrated in FIG. 7. In this configuration, the sound emitting end portion 46 is in close proximity to the ear canal and audio such as voice communications or music is acoustically coupled to the ear canal 20 to provide good listening for example in call management listening applications.

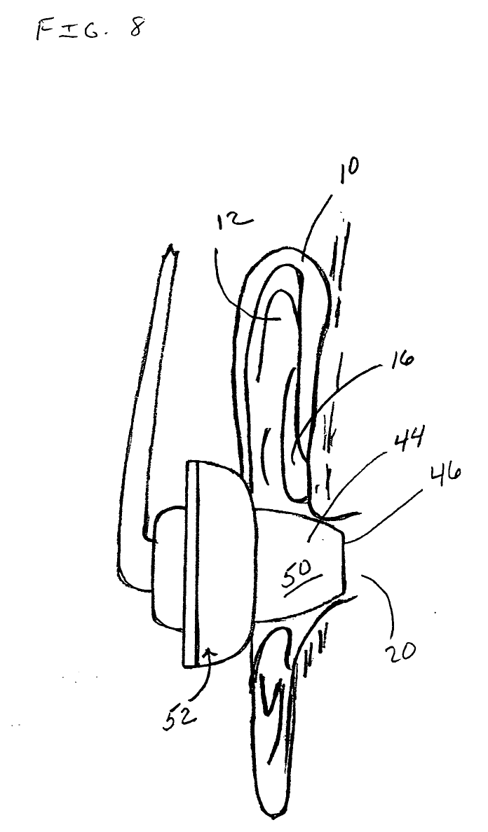

As illustrated in FIG. 6, the outer peripheral cup wall 52 is folded back and defines a folded rim generally designated 62 wherein the earplug 34 is configured to its second operative configuration for interfacing with the ear canal of a user for music listening applications. In this configuration, the folded back outer peripheral cup wall has a second axial length dimension 64 in its second operative state less than its first axial length dimension 56 in its first operative state such that the sound emitting end portion 46 of the communication channel member 44 extends a second distance dimension 66 above a plane passing transversely through the folded rim of the cup wall 52 such that the outer surface 50 of the communication channel member 44 is positioned in contact with the lower concha and entry to the ear canal 20 as illustrated in FIG. 8 to tightly acoustically couple audio such as music to the listener's ear in a music listening application.

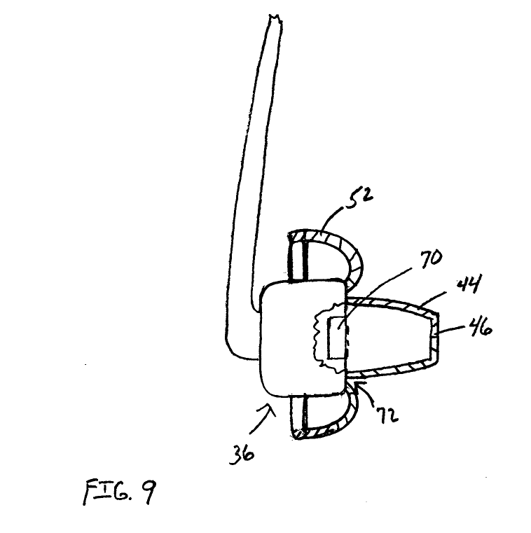

Turning now to FIG. 9, a schematic cross section having a partially cut away view of the earplug 34 of the headset embodying the present invention is illustrated therein in its second operative configuration wherein the speaker element 70 is arranged and carried by the main body element 36 such that sound produced by the speaker element 40 is transferred via the communication channel member 44 to the sound emitting end portion 46 to acoustically couple the sound to the user's ear canal when the headset is worn by the user. The outer peripheral cup wall 52 is shown folded back to configure the earplug for a music listening application. The speaker element 70 is a conventionally known 10 millimeter speaker or any other suitable speaker capable of carrying out the intended function. In instances where a user does not desire to insert the communication channel member 44 into the ear canal, a larger traditional speaker such as a 13 to 14 millimeter speaker may be utilized to provide a good music listening experience when the earplug is in its first operative configuration wherein the sound emitting end portion 46 is held in a spaced relationship with the ear canal. The communication channel member 44 is substantially concentric with the outer peripheral cup wall 52 and the end of the communication channel member 44 opposite the sound emitting end 46 is in a spaced relationship 72 with the outer peripheral cup wall 52 at the attachment point to the main body element 36.

The material of the outer peripheral cup wall may be of any suitable material that retains its shape and includes silicon or other soft plastic materials known to those skilled in the art for carrying out the intended functions. Preferably, the material is a non-allergenic material and is non-reactive with sweat, hair chemicals, bodily fluids and the like. Preferably, the material is compliant to provide a tight and comfortable fit to the user's ear. The material of the communication channel member may be of any suitable material to carry out the intended function and includes materials similar to the material of the outer peripheral cup wall.

It will also recognized that the configurable earplug embodying the present invention may be arranged as an “over the ear” earplug for use by a user or in other configurations and arrangements other than that illustrated here and above.

The invention claimed is:

1. An earphone for multiple applications, comprising:
a main body element having a first side defining an ear facing portion and second side disposed in a spaced relation opposite said first side and defining a closed portion;
said ear facing portion being configurable and having two operative states, said first state defining a first ear canal interface for call management listening applications and said second state defining a second ear canal interface for music listening applications.

2. The earphone as defined in claim 1 wherein said ear facing portion further comprising:
a communication channel member having a sound emitting end portion and a pre-defined axial length dimension, and further having a suitably sized and shaped outer surface for complementary engagement with the outer portion of the entry to the ear canal;
an outer peripheral cup wall, substantially concentric and in a spaced relation with said communication channel member and the rim of the cup wall, suitably sized and shaped for overlapping coverage and contact with the ear;
said outer peripheral cup wall comprising a suitable memory retention deformable material and having a first axial length in said first operative state wherein the sound emitting end portion of said communication channel member extends a first distance above a plane passing transversely through the rim of the cup wall such that the sound emitting end portion of said communication channel member is positioned in a spaced distance with respect to the entry to the ear canal;
said outer peripheral cup wall being folded back and defining a folded rim having a second axial length less than its first axial length in its second operative state wherein the sound emitting end portion of said communication channel member extends a seconds distance above a plane passing transversely through the folded rim of the cup wall such that the outer surface of said communication channel member sound emitting end portion is positioned in contact with the entry to the ear canal.

3. The earphone as defined in claim 1 further comprising a speaker element carried by said main body element producing audio signals.

4. The earphone as defined in claim 2 wherein said outer peripheral cup wall is made of an elastomer material.
